(19) United States
(12) Patent Application Publication
(10) Pub. No.: US 2026/0211119 A1
(43) Pub. Date: Jul. 23, 2026

(54) THREE-DIMENSIONAL IMAGING SYSTEM AND METHOD

(71) Applicant: Wayne State University, Detroit, MI (US)

(72) Inventors: Wen Li, Troy, MI (US); Suk Kyoung Lee, Troy, MI (US); Blessed Oguh, Detroit, MI (US); Sulaiman Abubakar, Detroit, MI (US)

(21) Appl. No.: 19/456,000

(22) Filed: Jan. 22, 2026

Related U.S. Application Data
(60) Provisional application No. 63/748,211, filed on Jan. 22, 2025.

(51) Int. Cl. G01S 17/894; G01S 7/4865; G06T 7/73; G06T 17/00; H04N 23/90

(52) U.S. Cl. CPC G01S 17/894; G01S 7/4865; G06T 7/74; G06T 17/00; H04N 23/90; G06T 2207/10028; G06T 2207/20216; G06T 2210/56

(57) ABSTRACT

A 3D imaging system may include a laser source, a camera arranged and oriented to collect reflected photons of a laser pulse emitted by the laser source, a master trigger connected to the laser source and/or the camera, and a computer communicatively coupled to the camera. The camera may be configured to accumulate a plurality of frames and/or to provide a first output signal including the plurality of frames and/or an averaged intensity image. The computer may be configured to receive the first output signal, receive a second output signal including a normal intensity image, provide a normalized averaged intensity image via normalizing the averaged intensity image based on the normal intensity image, determine a plurality of distances based on the normalized averaged intensity image and a brightness-distance calibration curve, and/or provide a 3D point cloud based on the plurality of determined distances and a plurality of pixel positions.

### CROSS-REFERENCE TO RELATED APPLICATIONS

This application claims priority to U.S. Provisional Patent Application No. US 63/748,211, filed on Jan. 22, 2025, the contents of which is hereby incorporated by reference in its entirety.

### STATEMENT REGARDING FEDERALLY SPONSORED RESEARCH AND DEVELOPMENT

This invention was made with government support under PHY2409529 awarded by NATIONAL SCIENCE FOUNDATION. The government has certain rights in the invention.

### TECHNICAL FIELD

The present disclosure generally relates to a 3D imaging system (e.g., a LiDAR system and/or device), particularly to a low-cost and high performing 3D imaging system, and a method of 3D imaging.

### BACKGROUND

Light detection and ranging (LiDAR), as one type of implementation of three-dimensional (3D) imaging, is a technique to map the surrounding environment. Recently, LiDAR technology has attracted much attention because of the important role it plays in advanced driver assistance systems (ADAS) and drone guidance systems. Over the years, many types of LiDAR designs have been developed. These include time-of-flight (TOF) and frequency-modulated continuous wave (FMCW) among other short-range 3D imaging methods such as laser triangulation, stereo vision, and the structured light method.

The TOF technique is based on the principle of propagation of light. Knowing that the speed of light is constant, it measures the distance traveled by a beam of light from the point of emission to the target object and back to the detector. TOF techniques are advantageous over stereo vision and light projection techniques because they do not require complex reconstruction mechanisms.

TOF lidars are categorized as i) direct TOF (DTOF) sensors in which the TOF is directly measured with time-resolving detectors and electronics or ii) indirect TOF (ITOF) sensors which involve the measurement of phase difference between the emitted and the backscattered light signals. ITOF sensors have achieved a high spatial resolution and can detect multiple objects over a large field of view. However, they are only limited to a short distance. DTOF sensors on the other hand measure the round-trip time it takes for a light pulse that is emitted towards a target and then backscattered to the detector. The distance of the target to the detector can be determined from the TOF of the reflected photons using the formula D=ToF×c/2, where c is the speed of light. The DTOF method has a long-range advantage over ITOF and does not require complex phase demodulation, making DTOF methods easier to implement.

Recent research efforts in DTOF techniques focus on enhancing the resolution, range, efficiency, and reliability of the systems. Improvements in detector technology such as Single-Photon Avalanche Diodes (SPADs), Silicon Photomultipliers (SiPMs), Avalanche Photodiodes (APDs), charge-coupled devices (CCDs) and advanced timing electronics aim to reduce jitter and improve resolution. Due to their large number of pixels, high sensitivity, and excellent timing resolution, SPAD arrays poise to be the ideal options for DTOF-LiDAR.

Thus, there is a need for an improved 3D imaging system (e.g., an improved LiDAR system and/or device) and method for 3D imaging that minimizes or eliminates one or more challenges or shortcomings of existing 3D imaging systems and methods.

### SUMMARY

According to an implementation, a 3D imaging system may include a laser source, a camera, a master trigger, and a computer. The laser source may be configured to emit a laser pulse. The camera may be arranged and oriented to collect reflected photons of the laser pulse emitted by the laser source. The camera may be configured to accumulate a plurality of frames and/or to provide a first output signal including the plurality of frames and/or an averaged intensity image. The master trigger may be connected to the laser source and/or the camera. The master trigger may be configured to provide a laser trigger signal to the laser source. The computer may be communicatively coupled to the camera. The computer may be configured to receive the first output signal from the camera, receive a second output signal including a normal intensity image, provide a normalized averaged intensity image via normalizing the averaged intensity image based on the normal intensity image, determine a plurality of distances based on the normalized averaged intensity image and a brightness-distance calibration curve, and/or provide a 3D point cloud based on the plurality of determined distances and a plurality of pixel positions.

According to an implementation, a method of 3D imaging may include sending a laser trigger signal to a laser source, sending a camera trigger signal to a camera with a delay, emitting a laser pulse via the laser source, shuttering the camera to measure reflected photons of the laser pulse and capture a frame, and accumulating a plurality of frames with the camera. The method may further include sending a first output signal from the camera to a computer and sending a second output signal to the computer. The first output signal may include the plurality of accumulated frames and/or an averaged intensity image. The second output signal may include a normal intensity image. The method may also include i) normalizing, via the computer, the averaged intensity image based on the normal intensity image to obtain a normalized averaged intensity image, ii) determining, via the computer, a plurality of distances based on the normalized averaged intensity image and a brightness-distance calibration curve, and iii) providing, via the computer, a 3D point cloud including a plurality of 3D coordinates based on the plurality of determined distances and a plurality of pixel positions.

Various other features and advantages will be made apparent from the following detailed description and the drawings.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a schematic illustration of an exemplary 3D imaging system;

FIG. 2 is a schematic illustration of a second exemplary 3D imaging system;

FIG. 3 is a schematic illustration of a third exemplary 3D imaging system;

FIG. 4 is a schematic illustration of a fourth exemplary 3D imaging system; and

FIGS. 5A and 5B are a flow chart of a first exemplary method of 3D imaging using the disclosed 3D imaging system, such as the system of FIG. 1 and/or the system of FIG. 3;

FIGS. 6A and 6B are a flow chart of a second exemplary method of 3D imaging using the disclosed 3D imaging system, such as the system of FIG. 1 and/or the system of FIG. 3;

FIGS. 7A and 7B are a flow chart of a third exemplary method of 3D imaging using the disclosed 3D imaging system, such as one of the systems of FIGS. 1-4;

FIGS. 8A and 8B are a flow chart of a fourth exemplary method of 3D imaging using the disclosed 3D imaging system, such as the system of FIG. 3;

FIGS. 9A and 9B are a flow chart of a fifth exemplary method of 3D imaging using the disclosed 3D imaging system, such as the system of FIG. 3 and/or the system of FIG. 4;

FIGS. 10A and 10B illustrate the rising edge and the falling edge of an exemplary camera shutter, respectively;

FIG. 11 is an exemplary pixel brightness vs. time graph showing the brightness of a pixel contacted by photon pulses at three different times overlayed by the pixel sensitivity/gain during a first camera shutter and the pixel sensitivity/gain during a second camera shutter;

FIGS. 12A and 12B illustrate an exemplary characterization of the frame-to-frame variation in actual shutter opening time and intensity ratio of a camera with shutter jitter and a camera without shutter jitter, respectively;

FIG. 13 is an exemplary graph of the pixel sensitivity/gain curve for several frames that are averaged together to produce an averaged intensity image overlapped by the time of flight curves for the reflected photons captured in the frames; and

FIG. 14 is an exemplary brightness-distance calibration curve.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

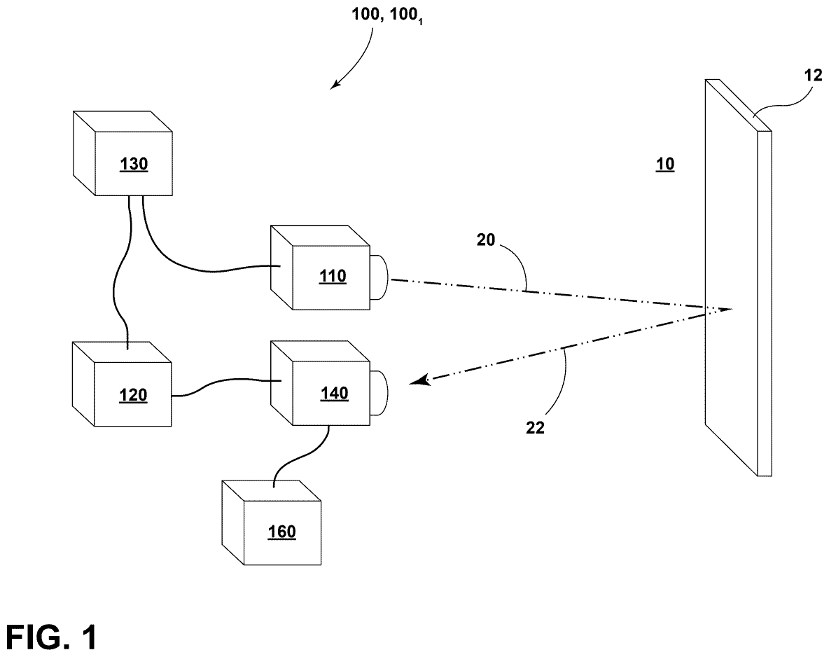

Disclosed is a three-dimensional (3D) imaging system 100 and method for 3D imaging that, unlike other conventional systems, does not utilize specialized timing devices or fast frame cameras. The disclosed system 100 also represents a significant simplification and cost-reduction in comparison with existing 3D imaging systems. The system 100 may be useful for a number of different applications and may be implemented differently (e.g., include additional components, features, and/or elements) based on the desired application. In some examples, such as those depicted in FIGS. 1-4, the system 100 is implemented in a LiDAR system and/or apparatus. The disclosed 3D imaging system 100 and method may be implemented and/or utilized in connection with vehicles (e.g., autonomous driving, collision warning, obstacle detection), (e.g., autonomous) drones, robotics, manufacturing (e.g., detecting working piece(s) and/or product(s), such as to initiate or trigger a manufacturing process in an assembly line), distribution/logistics (e.g., identifying objects and directing them to associated locations), and other technologies that commonly involve 3D imaging and/or LiDAR.

The disclosed system 100 and method of 3D imaging determines the distance of an object using one or more conventional 2D image sensors (e.g., cameras) by exploiting the finite rise/fall time of the electro-optical global shutter implemented in modern cameras, such as complementary metal-oxide semiconductor (CMOS) cameras. The system 100 employs one or more 2D image sensors 140, 150, which are complementary metal-oxide semiconductor (CMOS) cameras in the illustrative examples, to capture reflected photons 22 and utilizes i) pixel brightness totaled and/or averaged across a plurality of frames captured at various times within a predetermined time range, ii) pixel brightness during a full exposure period of a camera shutter, and iii) a brightness-distance calibration curve to extract, determine, and/or calculate the distance to the object 12 that reflected the photons 22 of the laser pulse 20 (e.g., the distance from the camera 140 to the object 12), which is then utilized to obtain and/or generate 3D coordinates (x-position, y-position, z-position) and/or 3D point clouds. In exemplary setups, the disclosed imaging system 100 and method has achieved a time precision of about one nanosecond and a range beyond 50 meters. The disclosed imaging system 100 and method thus provides a simple yet powerful alternative to conventional 3D imaging systems and methods.

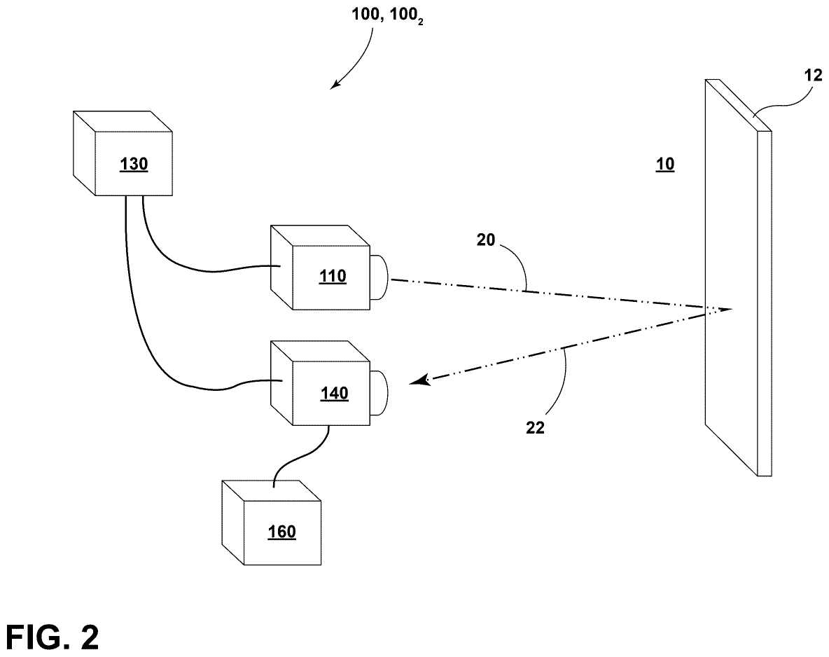

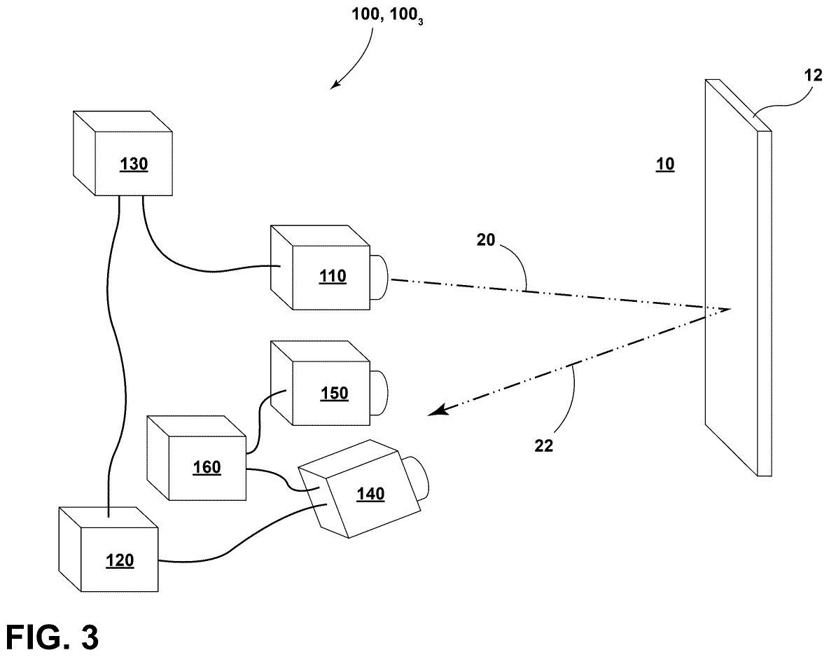

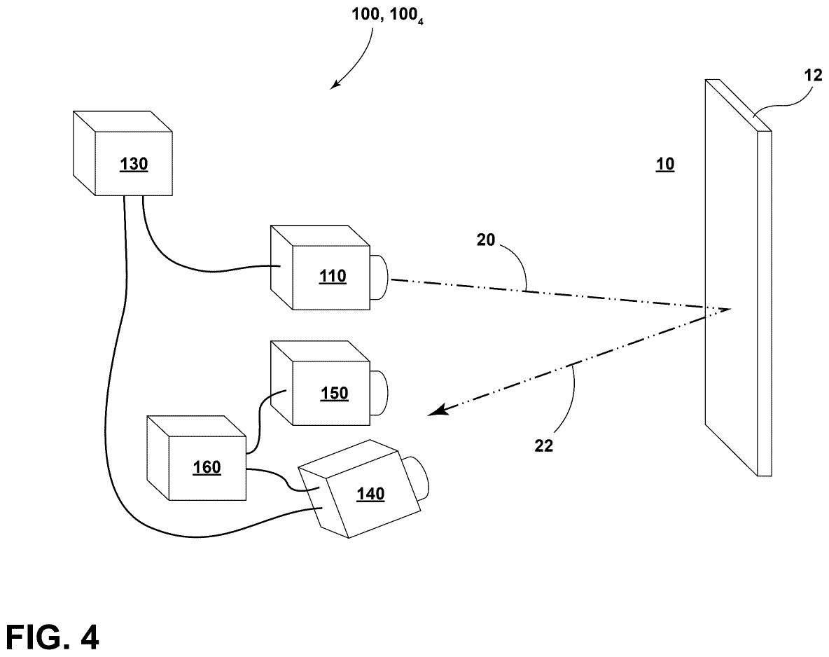

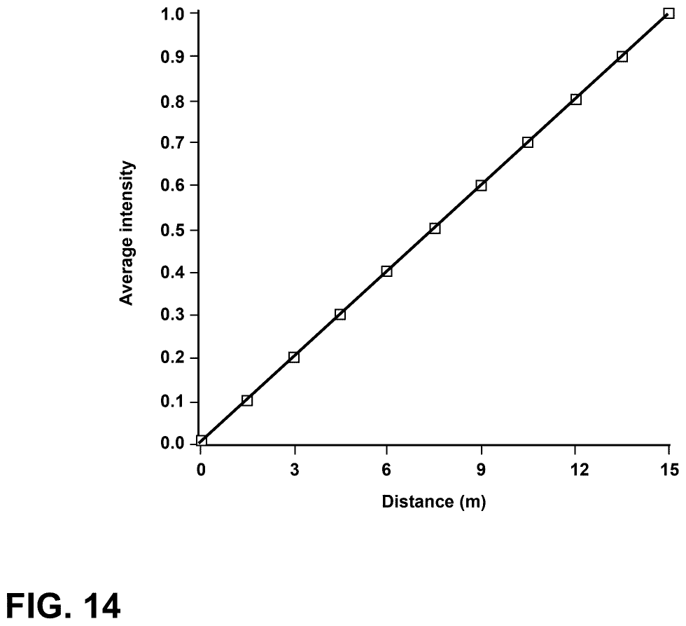

According to the disclosure, the system 100 includes i) a master trigger 130, ii) a laser source 110 configured to emit a laser, laser beam, and/or one or more laser pulses 20 (e.g., photons) into an environment 10 and/or to an object 12 that reflects one or more photons 22 of the laser pulse 20, the laser source 110 connected to and activatable and/or triggerable by the master trigger 130, iii) at least one camera (e.g., a first camera 140 and, optionally, a second camera 150) directed toward the environment 10 and connected (e.g., directly or indirectly) to the master trigger 130, and iv) a computer 160 communicatively connected to the first camera 140 for providing operations. Optionally, the system 100 includes i) a delay generator 120 connected to the master trigger 130 and the first camera 140 and/or ii) a second camera 150 directed toward the environment 10 and connected to the master trigger 130 and to the computer 160, the second camera 150 activatable and/or triggerable by the master trigger 130. The first camera 140 is connected directly to and directly activatable/triggerable by the delay generator 120 (see, e.g., FIGS. 1, 3) or the master trigger 130 (see, e.g., FIGS. 2, 4). The computer 160, for example, is configured to i) receive a first output signal from the first camera 140, ii) receive a second output signal from the first camera 140 and/or the second camera 150, iii) obtain, create, and/or produce a normalized averaged intensity image from and/or based on the first and second output signals (e.g., via normalizing an averaged intensity image included in, conveyed by, and/or derived from the first output signal utilizing a normal intensity image included in, conveyed by, and/or derived from the second output signal), iv) determine and/or calculate a distance for each pixel and/or each lit pixel of the normalized averaged intensity image using and/or based on a brightness-distance calibration curve (see, e.g., FIG. 14), v) determine a 3D coordinate associated with each pixel and/or each lit pixel of the normalized averaged intensity image (e.g., using and/or based on the position and/or location of the pixel within the sensor array and the calculated distance for the pixel), and vi) generate and/or provide a 3D point cloud for the normalized averaged intensity image. Optionally, the computer 160 is configured to generate 3D point clouds for a plurality of (e.g., sequentially generated) normalized averaged intensity images to provide real-time 3D imaging of the environment 10 and/or one or more objects 12 therein.

The laser source 110 is configured to emit a laser, laser beam, and/or one or more laser pulses 20 (i.e., photons) into an environment 10 and/or to an object 12 to provide one or more reflected photons 22. The laser source 110 is operatively (e.g., communicatively and/or physically) coupled to the master trigger 130 and is configured to be activated and/or triggered by the master trigger 130 (e.g., via receiving a laser trigger (LT) signal from the master trigger 130). The laser source 110 is positioned and oriented to emit the laser pulse 20 to one or more objects 12 disposed in the environment 10. Each laser pulse 20 is emitted into the environment 10 and strikes, contacts, and/or impinges on one or more objects 12 in the environment 10, which causes and/or results in the object 12 reflecting at least some photons of the laser pulse 20 back to the system 100, the laser source 110, and/or the camera(s) 140, 150 as reflected photons 22 and/or as one or more groups or pulses of reflected photons 22. For example, photons reflected by a first object 12 may be considered a first pulse of reflected photons 22 (i.e., a first photon pulse) and photons reflected by a different second object 12 may be considered a second pulse of reflected photons 22 (i.e., a second photon pulse), which may or may not have a different TOF than the first pulse of reflected photons 22.

The system 100 includes at least one 2D image sensor, which in the illustrative examples described herein, are configured, structured, and/or embodied as one or more cameras 140, 150. In some examples, such as the systems 100₁, 100₂ depicted in FIGS. 1 and 2, the system 100 includes a single camera 140. In other examples, such as the systems 100₃, 100₄ depicted in FIGS. 3 and 4, the system 100 includes two cameras - a first camera 140 for capturing and storing frames that will be averaged together to produce the averaged intensity image and a second camera 150 for capturing the frame for the normal intensity image. The first and second cameras 140, 150 are the same type of 2D image sensor (e.g., both are cameras) and are the same type of camera (i.e., include the same type of sensor array) in the illustrative examples herein, but may alternatively be different types of 2D image sensors and/or different types of cameras in other examples.

The first and second cameras 140, 150 are jointly described below for brevity. The camera 140, 150, which is a 2D image sensor, includes a sensor array with (e.g., millions) of photosensitive pixels covering a surface of the sensor array. The camera 140, 150 has a complementary metal-oxide semiconductor (CMOS) sensor array and/or is a CMOS camera in the illustrative examples described herein, but the camera 140, 150 may have a different type of sensor array (e.g., CCD, SPAD, etc.), may be a different type of camera (a CCD camera, sCMOS camera, and/or SPAD camera), and/or may be a different type of 2D image sensor in other examples. The pixels collect photons from light, which are converted to an electrical charge and transmitted as electrical signals. The sensor array may utilize a ‘global shutter’ in which all pixels of the sensor array are exposed simultaneously to capture a frame and/or image. Each activation (or shutter) of the camera 140, 150 and/or sensor array captures a single frame and/or image. When activated, triggered, and/or shuttered, the camera 140, 150 (e.g., a chip, ECU, processor, and/or control module thereof) is configured to gather, accumulate, and/or store (at least temporarily) the output of each pixel of the sensor array (e.g., the electrical charge produced by each photodiode of the CMOS sensor array) for the captured frame and/or image. Each captured frame is thus represented, formed, and/or defined by the pixel outputs of the sensor array that were gathered, accumulated, and/or stored by the camera 140, 150 when the camera 140, 150 was activated, triggered, and/or shuttered. The camera 140, 150 is configured to (at least temporarily) save, store, and/or accumulate one or more captured frames and/or images (e.g., a plurality of frames). It will be appreciated that the shutter is a mechanical or electronic curtain that controls the duration light hits the sensor.

In some examples, the first camera 140 is configured to create, produce, and/or generate an averaged intensity image from a group of frames (e.g., 100 frames, 1000 frames) that have been captured and stored/accumulated thereon. To create, produce, and/or generate an averaged intensity image, the first camera 140 is configured to average the output of each pixel across the stored and/or accumulate frames to obtain a plurality of averaged pixel outputs that collectively define the averaged intensity image. For example, the output of pixel A1 of each frame in the group of frames is added together to get a total pixel output for pixel A1 and that total pixel output is divided by the total number of frames in the group of frames to determine the averaged pixel output for pixel A1 in the averaged intensity image. This process is repeated for each pixel (e.g., pixel A2, A3, B1, B2, B3, C1, C2, C3, etc.) to determine a plurality of averaged pixel outputs that collectively define the averaged intensity image. Alternatively, the averaged intensity image may be defined directly by the plurality of total pixel outputs rather the plurality of averaged pixel outputs. Conceivably, the averaged intensity image can be produced and/or obtained by averaging any number of frames (e.g., 10-10,000 frames), such as 100 frames, 200 frames, 500 frames, and/or 1000 frames. Obtaining the averaged intensity image from a larger number of accumulate frames may improve the time precession of the system 100 and, thus, may be preferable in some situations. For example, in an exemplary system 100 having a camera shutter rise time of 0 ns and a jitter range of 100 ns, a time precision of 5 nanoseconds is achieved when the averaged intensity image is obtained from 100 frames while a time precision of less than 2 ns is achieved when the averaged intensity image is obtained from 1000 frames. Surprisingly, even with a more realistic camera shutter rise time (e.g., 10 ns), a substantially similar time precision (i.e., less than 2 ns) is achieved when the averaged intensity image is obtained from 1000 frames. Obtaining the averaged intensity image from a larger number of frames may also enable the system 100 (e.g., the camera 140, 150) to detect weaker signals (e.g., when one photon or less of each laser pulse 20 is reflected back and captured by the camera 140, 150) and thus extends the detection range of the system 100.

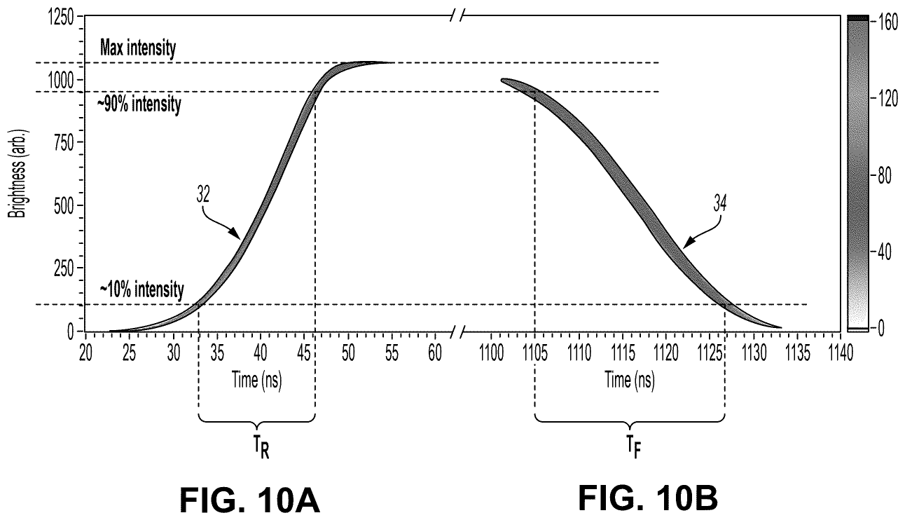

Each shutter of the camera 140, 150 (i.e., a camera shutter) has a time duration or an exposure time (e.g., 1 millisecond, 1 microsecond) during which the pixel sensitivity/gain remains constant (e.g., at 100% and/or max intensity). As generally illustrated in FIGS. 10A and 10B, the portion or region of the shutter process during which the pixel sensitivity/gain remains constant (e.g., at 100% and/or max intensity) may be considered and/or referred to as the full exposure period. The portion or region of the shutter process prior to the full exposure period during which the sensitivity/gain increases from 10% to 90% of max intensity may be considered and/or referred to as the rising edge 32 of the shutter. The amount of time for the sensitivity/gain to increase from 10% to 90% of max intensity is referred to as the rise time T_{R} (e.g., T_{R}=~12.9 ns in FIG. 10A). The portion or region of the shutter process following full exposure period during which the pixel sensitivity/gain decreases from 90% to 10% of max sensitivity/gain may be considered and/or referred to as the falling edge 34 of the shutter. The amount of time for the sensitivity/gain to decrease from 90% to 10% of max intensity is referred to as the fall time T_{F} (e.g., T_{F}=~19.6 ns in FIG. 10B). The rising edge 32 and the falling edge 34 are therefore separated by the exposure time (e.g., 1 millisecond, 1 microsecond), which is the time duration of the full exposure period of the shutter process.

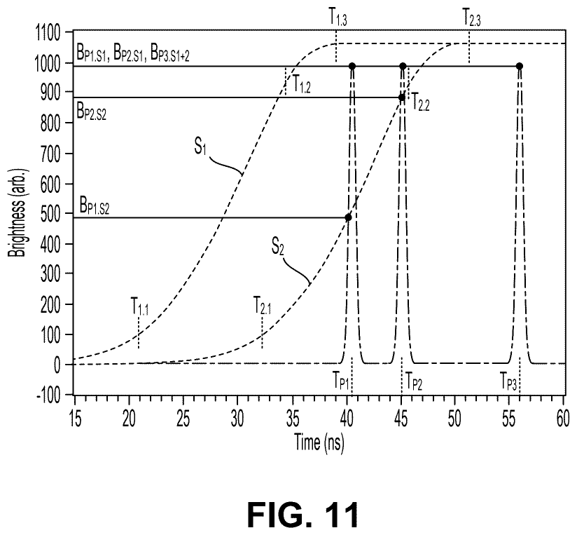

When reflected photons 22 arrive at and/or contact a pixel during the rising edge and/or the falling edge of the shutter of the camera 140, 150, the brightness of the pixel that is captured and/or detected in the frame is limited by the pixel sensitivity/gain during the rising and/or falling edge. In other words, the pixel sensitivity/gain during the rising and/or falling edge may prevent the full extent of the brightness of a pixel from being captured and/or detected in the frame. This is generally illustrated in the graph of FIG. 11 showing the brightness of a pixel contacted by three photon pulses at three different times overlayed by the pixel sensitivity/gain during a first shutter S₁ of the camera 140, 150 and the pixel sensitivity/gain during a second shutter S₂ of the camera 140, 150. In FIG. 11, a first photon pulse arrives at a first arrival time T_{P1}, a second photon pulse 22 arrives at a second arrival time T_{P2}, a third photon pulse arrives at a third arrival time T_{P3}, the rising edge of the first shutter S₁ begins at time T_{1.1} (e.g., due to shutter jitter) and ends at time T_{1.2}, the full exposure period of the first shutter S₁ starts at time T_{1.3}, the rising edge of the second shutter S₂ begins at time T_{2.1} (e.g., due to shutter jitter) and ends at time T_{2.2}, and the full exposure period of the second shutter S₂ starts at time T_{2.3}. Each photon pulse arrives at the camera 140, 150 i) after the end of the rising edge of the first shutter S₁ (i.e., rising edge end time T_{1.2} occurs before the arrival times T_{P1}, T_{P2}, and T_{P3}) and ii) during the full exposure period of the first shutter Sᵢ (i.e., full exposure start time T_{1.3} occurs before arrival times T_{P1}, T_{P2}, and T_{P3}) resulting in the camera 140, 150 capturing the full and/or maximum pixel brightness produced by each photon pulse 22 (e.g., a brightness of B_{P1.S1}, B_{P2.S1}, and B_{P3.S1+2} respectively) with the first shutter S₁. However, due to the pixel sensitivity/gain during the rising edge of the second shutter S₂, the camera 140, 150 would be unable to capture the full extent of the pixel brightness produced by the first and second photon pulses with the second shutter S_{C2}. The camera 140, 150 would only capture and/or detect a pixel brightness of B_{P1.S2} and B_{P2.S2} for the first and second photon pulses, respectively, with the second shutter S_{C2}. The first shutter S_{C1} and the second shutter S_{C2} would detect the same brightness, a pixel brightness of B_{P3.S1+2}, for the third photon pulse since it arrived during the full exposure period of the first shutter S1 and the second shutter S₂.

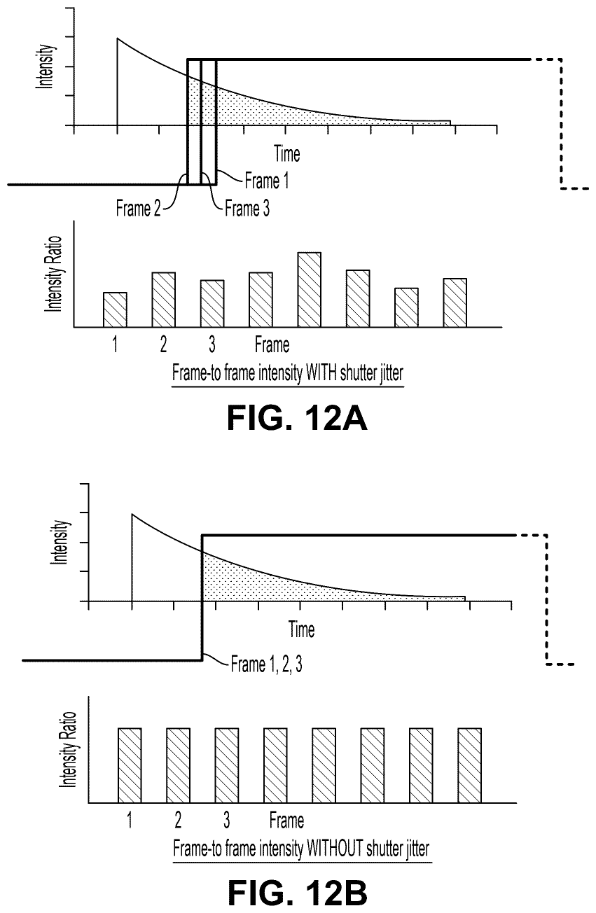

From frame to frame, there is a small variation in the amount of time between the shutter trigger time and the actual shutter opening time, which may be referred to as shutter jitter, trigger jitter, camera jitter, and/or camera shutter jitter. Practically speaking, all cameras inherently have shutter jitter. Shutter jitter is evidenced by the peak Ω value changing from shot to shot of the laser, and is further quantified with examining TOF distributions within a single laser shot. Shutter jitter, as well as the influence and/or impact of shutter jitter on the intensity ratio of the respective frame, is illustrated in FIGS. 12A and 12B. As depicted in FIG. 12A, frames 1, 2, and 3 all have the same trigger time but each have a slightly different actual shutter opening time due to shutter jitter (i.e., the rising edges occur at slightly different times and, thus, are offset from one another along the x-axis), which results in a slight variation in the intensity ratio from frame to frame. Conversely, as depicted in FIG. 12B, in a system 100 without shutter jitter the actual shutter opening time is constant from frame to frame (i.e., the rising edge of each frame occurs at the same time and, thus, are aligned with one another on the x-axis) and, as a result, the intensity ratio is also constant from frame to frame.

As generally illustrated in FIGS. 1-4, the cameras 140, 150 are oriented, aimed, and/or focused on an environment 10 and/or an object 12 disposed therein to capture, collect, detect, and/or measure the reflected photons 22 provided by the object 12 (e.g., photons of the laser pulse 20 emitted by the laser source 110 that have been reflected). The cameras 140, 150 are positioned and/or arranged in close proximity to one another (e.g., directly adjacent to one another vertically and/or horizontally). The cameras 140, 150 are arranged and oriented relative to one another such that the field of view of the first camera 140 and the field of view of the second camera 150 are substantially identical. As a result of the substantially identical fields of view, the amount of distortion and/or the differences between frames captured by the first camera 140 and frames captured by the second camera 150 are minimized, which results in the outputs (e.g., pixel brightnesses) of the second camera 150 providing a more accurate and/or precise normalization of the outputs (e.g., pixel brightnesses) of the first camera 140. In contrast, the cameras 140, 150 and the laser source 110 may not be aligned with one another (e.g., arranged vertically one above another; arranged side-by-side), may not be disposed adjacent and/or in close proximity to one another, and/or may be oriented in different directions. For example, the laser source 110 may be arranged within and/or be a part of a driver-side headlight of a vehicle and the cameras 140, 150 may be arranged within and/or be a part of a passenger-side headlight of the vehicle. In other examples, the laser source 110, the delay generator 120, the master trigger 130, and/or the camera(s) 140, 150 are arranged in close proximity to one another and, optionally, are disposed within and/or at least partially enclosed by a common housing.

The cameras 140, 150 are operatively (e.g., communicatively and/or physically) connected to the delay generator 120 (see, e.g., FIGS. 1 and 3) and/or the master trigger 130 (see, e.g., FIGS. 2 and 4). The first and second cameras 140, 150 are configured to receive and be activated, triggered, and/or shuttered by a first camera trigger signal and a second camera trigger signal, respectively, which signals are provided by the delay generator 120 (see, e.g., FIGS. 1 and 3) and/or the master trigger 130 (see, e.g., FIGS. 2 and 4).

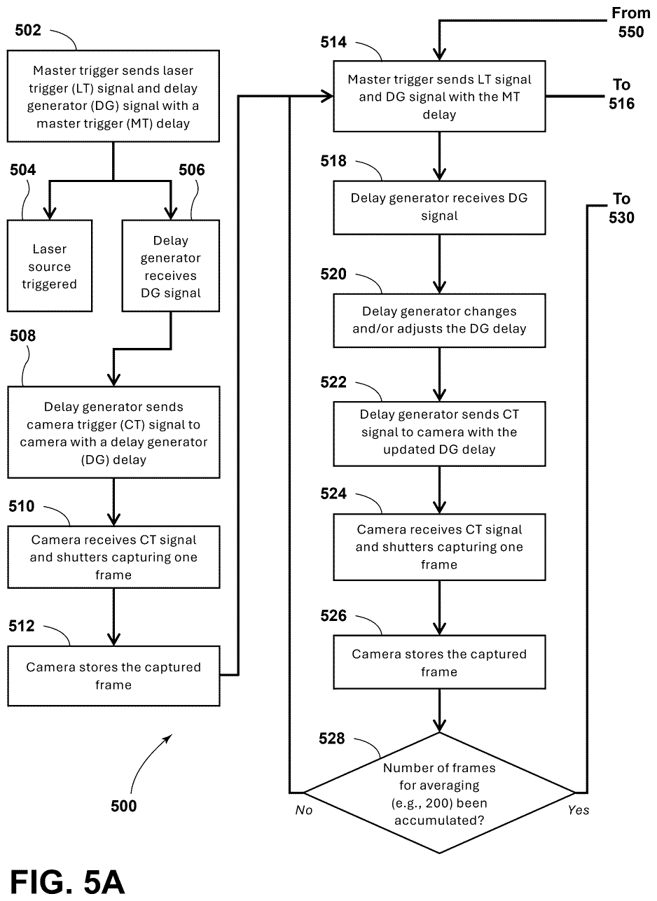

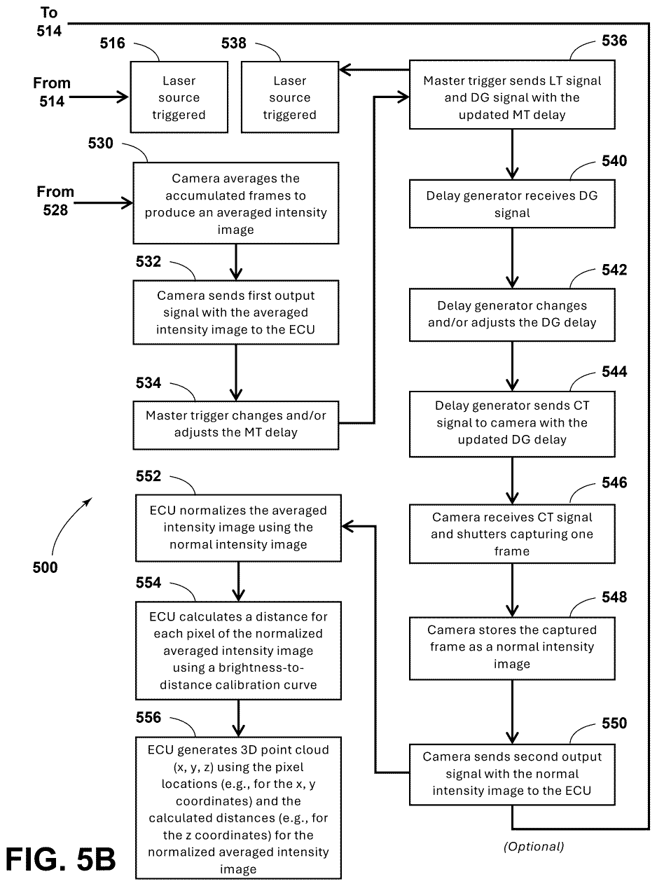

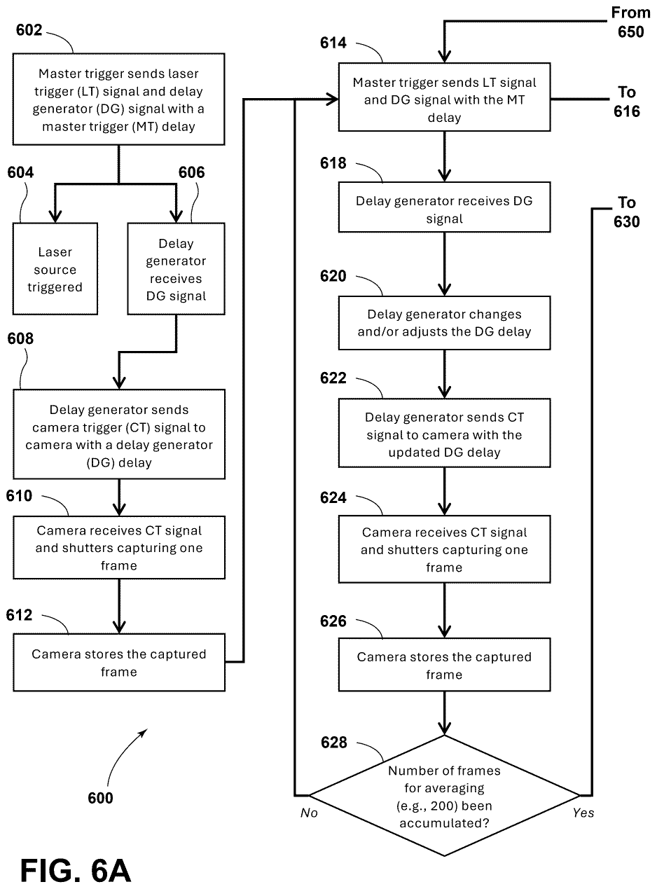

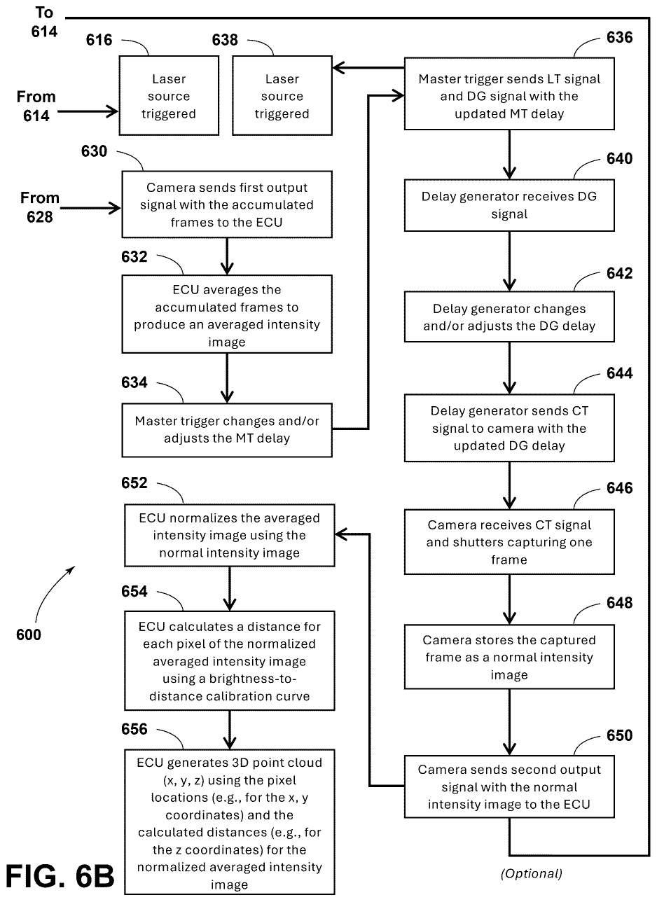

The cameras 140, 150 are also operatively (e.g., communicatively and/or physically) connected to the computer 160, and are configured to send a first output signal and a second output signal to the computer 160, respectively. In some examples (e.g., FIGS. 6A and 6B), the first output signal corresponds to and/or includes a group of frames (e.g., a plurality and/or predetermined number of frames) that have been captured by and stored/accumulated on the first camera 140. In other words, the first output signal includes the pixel outputs defining each frame in the group of frames (e.g., the pixel outputs defining a first frame, the pixel outputs defining a second frame, the pixel outputs defining a third frame, etc.). In other examples (e.g., FIGS. 5A, 5B, 7A-9B), the first output signal corresponds to and/or includes an averaged intensity image that is created, generated, and/or produced based on the group of frames that have been captured by and stored/accumulated on the first camera 140. The second output signal corresponds to a frame captured by the second camera 150 and includes the output of each pixel of a sensor array of the second camera 150, which collectively represent, form, and/or define the frame captured when the second camera 150 is activated, triggered, and/or shuttered. The frame captured by the second camera 150 and conveyed via the second output signal is typically utilized for normalization purposes and, thus, may be considered and/or referred to as a normal intensity image.

Optionally, the system 100 (e.g., the system 1001 of FIG. 1 and the system 1003 of FIG. 3) includes a delay generator 120. The delay generator 120 is operatively (e.g., communicatively and/or physically) coupled to the master trigger 130 and the first camera 140. Pursuant to an implementation, the delay generator 120 is and/or includes a circuit board (e.g., a printed circuit board), a processor, and/or one or more signal transmitters connected (e.g., via wires or electrical lines) to the master trigger 130 and the first camera 140. The delay generator 120 is configured to send signals, such as electrical pulse signals, to the first camera 140 and to receive signals, such as electrical pulse signals, from the master generator 130.

The delay generator 120 directly triggers and/or shutters the first camera 140 by sending a first camera trigger signal (C1T signal) causing the first camera 140 to capture a frame and/or image via measuring, detecting, and/or collecting reflected photons 22 of the laser pulse 20. The delay generator 120 is configured to send the C1T signal to the first camera 140 with a delay (a delay generator (DG) delay) to trigger and/or shutter the first camera 140. The length of the DG delay (i.e., the DG delay time) is the amount of time between the delay generator 120 receiving a delay generator signal (DG signal) from the master trigger 130 and when the C1T signal is sent.

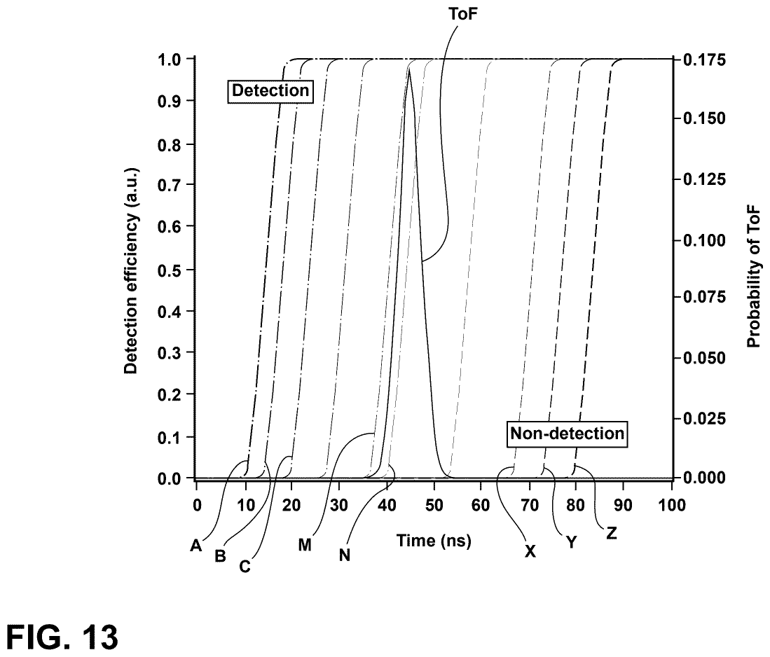

The delay generator 120 is configured and/or programmed to control, set, modify, and/or adjust the DG delay each time a frame is captured by the first camera 140. For example, the delay generator 120 is configured to modify the DG delay by modifying, adjusting, and/or changing (e.g., randomly, incrementally) the DG delay time within a predetermined time range, which may begin and/or start at a DG delay time of 0 ns. Stated alternatively, the delay generator 120 is configured to continually modify, adjust, and/or change the DG delay time within the predetermined time range while accumulating frames in the first camera 140 that will eventually be averaged, which may be referred to as ‘jittering’ the DG delay. By jittering the DG delay, the shutter opening time of each frame relative to when the laser source was triggered (i.e., the position of the rising edge of a frame in the x-direction in the graph of FIG. 13) varies amongst the captured and stored frames that are eventually averaged to create the averaged intensity image. This produces a ‘jitter’ or ‘jittering’ in the rising edge of the accumulated frames with respect time as generally illustrated in FIG. 13. Stated alternatively, the accumulated frames include a jittering rising edge and/or a jittering rising edge is present in and/or defined by the accumulated frames. This in turn results in a first subset of the frames (e.g., frames A, B, C) capturing and/or detecting the full brightness of the reflected photons from their associated laser pulse, a second subset of the frames (e.g., frames M, N) capturing and/or detecting some and/or a portion of the brightness of the reflected photons from their associated laser pulse, and a third subset of the frames (e.g., frames X, Y, Z) not capturing and/or detecting the reflected photons from their associated laser pulse. The number of frames included in each subset varies based on the distance between the camera 140, 150 and the object 12 that reflected the captured photons 22. For example, the TOF curve in FIG. 13 would be disposed farther to the left and less frames would capture the reflected photons 22 if the object 12 reflecting the photons 22 was disposed closer to the camera 140, 150. If the object 12 reflecting the photons 22 was disposed farther from the camera 140, 150, the TOF curve in FIG. 13 would be disposed farther to the right and more frames would capture the reflected photons 22. As such, averaging and/or totaling the pixel brightness across a plurality and/or group of frames captured within a predetermined time range provides a value that corresponds to, is associated with, and/or is indicative of the distance between the camera 140, 150 and the object 12 that reflected the photons 22. The distance between the camera 140, 150 and the object 12 can therefore be determined based on and/or from a brightness-distance calibration curve (see, e.g., FIG. 14) and the total and/or average pixel brightness for a plurality of frames.

FIG. 13 depicts an exemplary graph of the pixel sensitivity/gain curve for several frames (e.g., frames A, B, C, M, N, X, Y, Z) that are averaged together to produce an averaged intensity image overlapped by the time of flight curves for the reflected photons captured in the frames. Each frame captures the reflected photons of a respective laser pulse (e.g., frame A captures the reflected photons of a first laser pulse, frame B captures the reflected photons of a second laser pulse) as previously explained. For simplicity and ease of understanding, in FIG. 13, the laser trigger time for each frame is 0 ns and the same stationary object is struck by and reflects each laser pulse. As a result, the reflected photons captured in each frame have substantially identical time of flight curves and are therefore represented by a single time of flight curve ToF in FIG. 13.

The predetermined time range is determined, selected, and/or set based on the desired detection range of the system 100. Generally speaking, the maximum detection range of the system 100 is equal to the length of the predetermined time range (in nanoseconds) multiplied by 0.15 m/nanosecond. For example, a predetermined time range of around 0 ns-100 ns would achieve a maximum detection range of around 15 m (100 ns*0.15 m/ns=15 m). Additionally and/or alternatively, the minimum length for the predetermined time range that is necessary to achieve a desired detection range can be determined by multiplying the desired detection range by 6 ⅔ ns/m. For example, to achieve a maximum detection range of 50 m, the length of the predetermined time range would need to be at least 334 ns (50 m*6.67 ns/m=334 ns), so the predetermined time range would be set to 0 ns-334 ns to achieve a maximum detection range of 50 m.

The inherent shutter jitter of the first camera 140 also results and/or causes variation in the shutter opening time (i.e., the position of the rising edge with respect to time) as seen in FIG. 12A. As such, the inherent shutter jitter of the first camera 140 may be used in place of the ‘jitter’ or ‘jittering’ effect in the rising edge provided by the delay generator 120. A system 100 utilizing the inherent shutter jitter of the first camera 140 has a relatively short detection range, however, and may be impractical and/or have limited usefulness. For example, the first camera 140 may have an inherent shutter jitter of approximately 15 ns (i.e., the actual shutter opening time for each shutter of the first camera 140 varies by ±15 ns) and, thus, an inherent shutter jitter range of approximately 30 ns. The inherent shutter jitter range of the first camera 140 would effectively be the predetermined time range in such a system 100 and, thus, a maximum detection range of around 4.5 m (30 ns*0.15 m/ns=4.5 m) could be achieved.

The master trigger 130 is operatively (e.g., communicatively and/or physically) coupled to the laser source 110, the delay generator 120, and/or the cameras 140, 150. Pursuant to an implementation, the master trigger 130 is and/or includes a circuit board (e.g., a printed circuit board), a processor, and/or one or more signal transmitters connected (e.g., via wires or electrical lines) to the laser source 110, the delay generator 120, and/or the cameras 140, 150. The master trigger 130 is configured to send signals, such as electrical pulse signals, to the laser source 110, the delay generator 120, and/or the cameras 140, 150. A signal sent by the master trigger 130 to the laser source 110, the delay generator 120, the first camera 140, and the second camera 150 may be referred to as a laser trigger signal (LT signal), a delay generator signal (DG signal), a first camera trigger signal (C1T signal), and a second camera trigger signal (C2T signal), respectively. The signals provided by the master trigger 130 activate and/or trigger the laser source 110, the delay generator 120, and/or the cameras 140, 150.

The master trigger 130 triggers and/or activates the laser source 110, such as by sending the LT signal, causing the laser source 110 to emit a laser, laser beam, and/or one or more laser pulses 20 (i.e., photons). The time at which the master trigger 130 sends the LT signal and/or the laser source 110 emits the laser pulse 20 may be referred to as a laser trigger time.

In exemplary systems 100 including the delay generator 120, such as the systems 1001, 1003 of FIGS. 1 and 3, the master trigger 130 triggers and/or activates the delay generator 120, such as by sending the DG signal, causing the delay generator 120 to send one or more camera trigger signals (e.g., the C1T signal to the first camera 140 and/or the C2T signal to the second camera 150). The master trigger 130 sends the DG signal with a delay (a master trigger (MT) delay) relative to when the LT signal is sent. The length of the MT delay (i.e., the MT delay time) is the amount of time between when the master trigger 130 sends the LT signal and when it sends the DG signal. The master trigger 130 is configured and/or programmed to control, set, modify, and/or adjust the MT delay, such as by adjusting, modifying, and/or changing the MT delay time. The master trigger 130 modifies the MT delay to modify, adjust, and/or change the amount of time between triggering of the laser source 110 and triggering of one or more of the cameras 140, 150 (i.e., a laser-camera (LC) delay). The LC delay is also changed when jittering the DG delay as described above. Conceivably, the length of the MT delay may be 0 ns (i.e., the master trigger 130 may send the DG signal without a delay) in one or more situations and/or exemplary systems 100.

The master trigger 130 may be configured to modify, adjust, and/or change the MT delay so that the LC delay is different (e.g., longer) when capturing most of, if not all of, the frames that are averaged together to produce the averaged intensity image than when capturing the frame that will be used for normalization (i.e., as the associated normal intensity image). More specifically, the master trigger 130 may be configured such that the frame that is utilized as the normal intensity image is captured with a shorter MT delay and/or LC delay than most of, if not all of, the frames that are averaged together to produce the associated averaged intensity image.

The master trigger 130 is configured to set and/or adjust the MT delay and/or MT delay time (e.g., to a first delay duration) such that, when capturing the frames that are averaged together to produce the averaged intensity image, the shutter of the first camera 140 begins within the predetermined time range, which may be determined and/or selected based on the desired detection range of the system 100.

In exemplary systems 100 including a delay generator 120 and a single camera 140, such as the system 1001 of FIG. 1, the master trigger 130 is further configured to set and/or adjust the MT delay and/or MT delay time (e.g., to a second delay duration) such that, when capturing the frame for the normal intensity image, the first camera 140 is shuttered earlier and/or before photon arrival (i.e., the rising edge of the captured frame for the normal intensity image is to the left of the TOF curve like the rising edge of frames A, B, and C in the graph of FIG. 13). The master trigger 130, for example, may be configured to set and/or adjust the MT delay such that the first camera 140 shutters i) before the start of the predetermined time range or ii) at and/or about (e.g., slightly before and/or slightly after) the start of the predetermined time range when capturing the frame that is to be utilized as the normal intensity image. As a result, the reflected photons of the laser arrive at the first camera 140 during a fully open period of the shutter and the full and/or maximum pixel brightness produced by the reflected photons are captured by the first camera 140 in the normal intensity image.

In some examples, such as the system 1002 of FIG. 2 and the system 1004 of FIG. 4, the system 100 does not include a delay generator 120 and the functions and/or the configuration of the delay generator 120 described above are incorporated into and/or performed by the master trigger 130. In these examples, the master trigger 130 does not provide and/or send a DG signal. Rather, the master trigger 130 directly triggers and/or shutters the first camera 140 by sending the C1T signal causing the first camera 140 to capture a frame and/or image via measuring, detecting, and/or collecting reflected photons 22 of the laser pulse 20. The master trigger 130 is configured to send the C1T signal to the first camera 140 with a delay (a first camera (C1) delay) to trigger and/or shutter the first camera 140. The length of the C1 delay is the amount of time between when the master trigger 130 sends the LT signal and when it sends the C1T signal. The master trigger 130 is configured to continually modify, adjust, and/or change the C1 delay time (i.e., jitter the C1 delay) within the predetermined time range while capturing and accumulating frames in the first camera 140 that will eventually be averaged. This jittering of the C1 delay achieves the same result as jittering the DG delay described above.

The master trigger 130 is further configured to set and/or adjust the C1 delay and/or C1 delay time such that, when capturing the frames that are averaged together to produce the averaged intensity image, the shutter of the first camera 140 begins within the predetermined time range.

In exemplary systems 100 without a delay generator 120 and with a single camera 140, such as the system 1002 of FIG. 2, the master trigger 130 is also configured to set and/or adjust the C1 delay and/or C1 delay time such that, when capturing the frame for the normal intensity image, the first camera 140 is shuttered earlier and/or before photon arrival (e.g., before the start of the predetermined time range, at and/or about the start of the predetermined time range).

In exemplary systems 100 including two cameras 140, 150, such as the systems 1003, 1004 of FIGS. 3 and 4, the master trigger 130 triggers and/or shutters the second camera 150 by sending the C2T signal causing the second camera 150 to capture a frame and/or image via measuring, detecting, and/or collecting reflected photons 22 of the laser pulse 20. The master trigger 130 is configured to send the C2T signal to the second camera 150 with a delay (a second camera (C2) delay) to trigger and/or shutter the second camera 150. The length of the C2 delay (i.e., the C2 delay time) is the amount of time between when the master trigger 130 sends the LT signal and when it sends the C2T signal. The master trigger 130 is configured to set and/or adjust the C2 delay and/or C2 delay time such that the second camera 150 is shuttered earlier and/or before photon arrival (i.e., the rising edge of the captured frame for the normal intensity image is to the left of the TOF curve like the rising edge of frames A, B, and C in the graph of FIG. 13). The master trigger 130, for example, may be configured to set and/or adjust the C2T delay such that the second camera 150 shutters i) before the start of the predetermined time range or ii) at

and/or about (e.g., slightly before and/or slightly after) the start of the predetermined time range. As a result, the reflected photons of the laser arrive at the second camera 150 during a fully open period of the shutter and the full and/or maximum pixel brightness produced by the reflected photons are captured by the second camera 150 in the normal intensity image.

The computer 160 is operatively connected (e.g., communicatively and/or physically) to the first camera 140 and/or the second camera 150. The computer 160 includes a (one or more) processor and a memory that communicates with each other, and with other components, via a bus (e.g., a memory bus, a memory controller, a peripheral bus, a local bus, and any combinations thereof, using any of a variety of bus architectures). Memory can include various components (e.g., machine-readable media) including, but not limited to, a random-access memory component, a read-only component, and any combinations thereof. Memory can also include (e.g., stored on one or more machine-readable media) instructions (e.g., software) embodying any one or more of the aspects and/or methodologies of the present disclosure.

In some examples, such as in the method 600 of FIGS. 6A and 6B, the computer 160 is configured to create, produce, and/or generate an averaged intensity image from a group of frames received from the first camera 140 via the first output signal. The computer 160 may, for example, be configured to create, produce, and/or generate an averaged intensity image in the same way as the first camera 140 described above.

To account for the reflectivity difference in objects, the computer 160 is configured to normalize the averaged intensity image using the associated normal intensity image to produce and/or generate a normalized averaged intensity image. For example, the computer 160 may be configured to normalize the averaged intensity image via scaling the averaged intensity image by the associated normal intensity image. To scale the averaged intensity image by the associated normal intensity image, the computer 160 may be configured to divide the averaged brightness intensity value for each pixel of the averaged intensity image by the brightness intensity value of the corresponding pixel in the normal intensity image to obtain a plurality of normalized averaged brightness intensity value (i.e., a normalized averaged brightness intensity value for each pixel). The plurality of normalized averaged brightness intensity values collectively define and/or form the normalized averaged intensity image.

The computer 160 is also configured to determine and/or calculate a respective distance (e.g., a z-coordinate) for each pixel of the normalized averaged intensity image using a brightness-distance calibration curve, such as the one shown in FIG. 14.

The computer 160 is further configured to generate a 3D point cloud for the normalized averaged intensity image using the positions and/or locations of the pixels and the calculated distances. The computer 160 may, for example, be configured to determine a plurality of 3D coordinates (x, y, z) for the normalized averaged intensity image using the positions and/or locations of the pixels, such as the position of the pixel within the sensor array (e.g., for the x, y coordinates), and the calculated distances (e.g., for the z-coordinates) of the pixels of the normalized averaged intensity image. For each 3D coordinate, the computer 160 may be configured to i) determine the x-coordinate and the y-coordinate from and/or based on a pixel's position on the sensor array and ii) determine the z-coordinate based on the determined/calculated distance associated with that pixel. The computer 160 is further confirmed to compile, plot, map, and/or assembly the plurality of 3D coordinates in the same 3D coordinate system to generate the 3D point cloud for the normalized averaged intensity image. Optionally, the computer 160 is configured to generate 3D point clouds for a plurality of (e.g., sequentially generated) normalized averaged intensity images to provide real-time 3D imaging of the environment 10 and/or one or more objects 12 therein.

A first exemplary method 500 of 3D imaging with the disclosed system 100, such as with the system 1001 of FIG. 1 and/or with the system 1003 of FIG. 3, is generally depicted in FIGS. 5A and 5B and described below.

At block 502 of method 500, the master trigger 130 sends a laser trigger signal (LT signal) to the laser source 110 and sends a delay generator signal (DG signal) to the delay generator 120 with a master trigger delay (MT delay). The master trigger 130 may determine and/or set the MT delay such that the shutter of the first camera 140 at block 510 begins within the predetermined time range.

At block 504, the laser source 110 receives the LT signal from the master trigger 130. The LT signal activates and/or triggers the laser source 110 causing the laser source 110 to emit a pulse of emissions 20 (e.g., a laser and/or a plurality of laser pulses). The laser pulses 20 eventually strike, contact, and/or impinge on one or more objects 12 in the environment 10, which causes and/or results in the objects 12 providing (e.g., reflecting, generating, releasing, emitting, etc.) one or more particles (e.g., reflected photons 22).

At block 506, the delay generator 120 receives the DG signal from the master trigger 130.

At block 508, the DG signal activates and/or triggers the delay generator 120 causing the delay generator 120 to send a first camera trigger signal (C1T trigger signal) to the first camera 140 with a delay generator delay (DG delay).

At block 510, the first camera 140 receives the C1T signal from the delay generator 120. The C1T signal activates, triggers, and/or shutters the first camera 140 and/or its sensor array to measure and/or collect the reflected photons 22 of the laser 20 and capture a frame.

At block 512, the first camera 140 saves and/or stores the captured frame.

At block 514, the master trigger 130 sends another (e.g., a second) LT signal to the laser source 110 and sends another (e.g., a second) DG signal to the delay generator 120 with the MT delay.

At block 516, the laser source 110 receives the LT signal from the master trigger 130 and the processes described above with respect to block 504 are repeated.

At block 518, the delay generator 120 receives the DG signal from the master trigger 130.

At block 520, in response to receiving the DG signal, the delay generator 120 modifies, adjusts, and/or changes the DG delay. Modifying, adjusting, and/or changing the DG delay includes changing and/or adjusting the DG delay within a predetermined time range, such as switching and/or changing the DG delay from one time, number, and/or value within the predetermined time range to another/different time, number, and/or value within the predetermined time range.

At block 522, the delay generator 120 sends the C1T signal to the first camera 140 with the updated and/or modified DG delay from block 520.

At block 524, the first camera 140 receives the C1T signal from the delay generator 120. The C1T signal activates, triggers, and/or shutters the first camera 140 and/or its sensor array to measure and/or collect the reflected photons 22 of the laser 20 and capture another frame (e.g., a second frame).

At block 526, the first camera 140 saves and/or stores the frame captured at block 524.

At block 528, the first camera 140 determines whether a sufficient and/or predetermined number of captured frames have been stored and/or accumulated to form and/or produce an averaged intensity image. Determining whether a sufficient and/or predetermined number of captured frames have been stored and/or accumulated may include comparing the number of captured and stored frames to the predetermined number of frames that are to be utilized to produce an averaged intensity image. This predetermined number of frames may be tens, hundreds, and/or thousands of frames, such as 10, 100, 550, 700, or 1000 frames for example. If a sufficient number of captured frames have not been stored and/or accumulated (e.g., the number of captured and stored frames<the predetermined number of frames), the method 500 returns to block 514 and the steps/processes of blocks 514-528 described above are repeated in a looped manner to capture, store, and accumulate a sufficient number of frames (e.g., the predetermined number of frames) to produce an averaged intensity image. As such, while capturing, storing, and/or accumulating frames in the first camera 140 to produce the averaged intensity image, the method 500 includes continually adjusting and/or modifying the DG delay within the predetermined time range (i.e., jittering the DG delay) with and/or via the delay generator 120 such that the accumulated frames include a jittering rising edge and/or a jittering rising edge is present in and/or defined by the accumulated frames (e.g., the amount of time between the shutter opening time and the associated laser source trigger time varies amongst the accumulate frames causing the rising edge to appear to jitter with respect to time across the plurality of frames). Once a sufficient number of captured frames have been stored and/or accumulated (e.g., the number of captured and stored frames =the predetermined number of frames), the method 500 proceeds to block 530.

At block 530, the first camera 140 (e.g., the chip, ECU, processor, and/or control module thereof) creates, produces, and/or generates an averaged intensity image from the group of frames that have been captured and stored/accumulated thereon. Creating the averaged intensity image may include averaging the output (e.g., the brightness intensity value) of each pixel across the stored/accumulated frames to obtain a plurality of averaged pixel outputs (e.g., a plurality of averaged brightness intensity values) that collectively define the averaged intensity image. Alternatively, creating the averaged intensity image may include summing and/or totaling the output (e.g., the brightness intensity value) of each pixel across the stored/accumulated frames to obtain a plurality of total pixel outputs (e.g., a plurality of total brightness intensity values) that collectively define the averaged intensity image.

At block 532, the first camera 140 (e.g., the chip, ECU, processor, and/or control module thereof) generates and/or provides a first output signal, which includes the averaged intensity image, and transmits the first output signal to the computer 160.

At block 534, the master trigger 130 modifies, adjusts, and/or changes the MT delay for capturing a normal intensity image that will be associated with the averaged intensity image provided to the computer 160 at block 532. Modifying, adjusting, and/or changing the MT delay includes reducing and/or shortening the MT delay relative to the MT delay that was utilized when capturing, storing, and/or accumulating frames on the first camera 140 at blocks 502-528. The master trigger 130 may determine, set, and/or modify the MT delay such that the shutter of the first camera 140 at block 546 begins earlier than and/or before arrival of the reflected photons 22 (e.g., before the start of the predetermined time range, at and/or about the start of the predetermined time range) and the reflected photons 22 arrive at the first camera 140 during a fully open period of the shutter.

At block 536, the master trigger 130 sends a LT signal to the laser source 110 and sends a DG signal to the delay generator 120 with the modified and/or updated MT delay from block 534.

At block 538, the laser source 110 receives the LT signal from the master trigger 130 and the processes described above with respect to block 504 are repeated.

At block 540, the delay generator 120 receives the DG signal from the master trigger 130.

At block 542, in response to receiving the DG signal, the delay generator 120 modifies, adjusts, and/or changes the DG delay as described above with respect to block 520. Note that block 542 is optional and the method 500 may proceed directly from block 540 to block 544 in some examples.

At block 544, the delay generator 120 sends the C1T signal to the first camera 140 with the updated and/or modified DG delay from block 542.

At block 546, the first camera 140 receives the C1T signal from the delay generator 120. The C1T signal activates, triggers, and/or shutters the first camera 140 and/or its sensor array to measure and/or collect the reflected photons 22 of the laser 20 and capture a frame that is to be utilized as the normal intensity image. As such, this captured frame defines and/or forms the normal intensity image, and/or may simply be considered to be the normal intensity image.

At block 548, the first camera 140 saves and/or stores the frame captured at block 546 (i.e., the normal intensity image).

At block 550, the first camera 140 (e.g., the chip, ECU, processor, and/or control module thereof) generates and/or provides a second output signal, which includes the normal intensity image, and transmits the second output signal to the computer 160.

At block 552, the computer 160 normalizes the averaged intensity image using the associated normal intensity image to produce, create, and/or generate a normalized averaged intensity image. For example, the computer 160 may normalize the averaged intensity image via scaling the averaged intensity image by and/or with the associated normal intensity image. Scaling the averaged intensity image by the associated normal intensity image may include dividing the averaged output (e.g., the averaged brightness intensity value) of each pixel of the averaged intensity image by the brightness intensity value of the corresponding pixel of the normal intensity image to obtain a plurality of normalized averaged pixel outputs (e.g., a plurality of normalized averaged brightness intensity values) that collectively define the normalized averaged intensity image.

At block 554, the computer 160 determines and/or calculates a respective distance (e.g., a z-coordinate) for each pixel of the normalized averaged intensity image, such as with and/or by utilizing a brightness-distance calibration curve. For example, to determine the distance for a pixel of the normalized averaged intensity image, the computer 160 determines, finds, and/or locates a distance associated with a point on the brightness-distance calibration curve, such as the one shown in FIG. 14, having a pixel brightness value corresponding and/or equal to the normalized averaged pixel brightness for the pixel. As an example, for an exemplary first pixel in the normalized averaged intensity image having a normalized averaged pixel brightness of B₁, the computer 160 determines, finds, and/or locates point P₁ on the brightness-distance calibration curve with a pixel brightness value corresponding and/or equal to the normalized averaged pixel brightness B₁, and determines, finds, and/or locates the distance D₁ associated with point P₁ on the brightness-distance calibration curve. The computer 160 would thus determine that the exemplary first pixel of the normalized averaged intensity image and/or the reflected photon pulses 22 associated therewith have a measured distance of D₁.

At block 556, the computer 160 generates and/or provides a 3D point cloud for the normalized averaged intensity image based on the determined/calculated distances and the relative positions and/or locations of the pixels on the sensory array of the first camera 140. To generate and/or provide a 3D point cloud, the computer 160 determines and/or obtains a plurality of 3D coordinates (x-position, y-position, z-position) each of which are associated with a respective pixel of the normalized averaged intensity image. The computer 160 may determine and/or obtain the 3D coordinate for each pixel of the normalized averaged intensity image based on the pixel's respective calculated/determined distance from block 554 and the pixel's respective position (x-position, y-position) on the sensor array of the first camera 140. A pixel's position (x-position, y-position) on the sensor array of the first camera 140 may correspond to and/or be based on the pixel's position in a pixel grid (e.g., the pixel's position in the fifth column and fourth row of the pixel grid). The computer 160 may then map, compile, plot, and/or assemble the plurality of 3D coordinates in the same 3D coordinate system to generate, produce, and/or obtain a 3D point cloud for the normalized averaged intensity image.

Optionally, the method 500 may include continually repeating the above-described processes and/or steps to generate 3D point clouds for a plurality of (e.g., sequentially generated and/or produced) normalized averaged intensity images to provide real-time 3D imaging of the environment 10 and/or one or more objects 12 therein. In the exemplary method 500 of FIGS. 5A and 5B for example, after the first camera 140 has sent the second output signal at block 550, the method 500 returns to block 514 and the process of capturing, storing, and accumulating the next group of frames to produce another averaged intensity image (e.g., via performing blocks 514-528 in a looped manner) is commenced while the computer 160 normalizes the previous normalized averaged intensity image, determines the distances, and generates a 3D point cloud for the normalized averaged intensity image at blocks 552-556. Alternatively, the method 500 may return to block 514 after the computer 160 has generated and/or produced the 3D point cloud at block 556.

A second exemplary method 600 of 3D imaging with the system 100, such as the system 1001 of FIG. 1 and/or the system 1003 of FIG. 3, is generally depicted in FIGS. 6A and 6B. The second method 600 is similar to the first method 500 with the exception of blocks 530, 532 of method 500 and blocks 630, 632 of method 600. Where the first camera 140 produces the averaged intensity image and sends the averaged intensity image to the computer 160 via the first output signal at blocks 530, 532 of method 500, the stored/accumulated frames are provided from the first camera 140 to the computer 160 via the first output signal and the computer 160 creates, generates, and/or produces the averaged intensity image at blocks 630, 632 of method 600. More specifically, at block 630, the first camera 140 (e.g., the chip, ECU, processor, and/or control module thereof) generates and/or provides a first output signal, which includes the captured frames that were stored and/or accumulated on the first camera 140, and transmits the first output signal to the computer 160. At block 632, the computer 160 creates, produces, and/or generates an averaged intensity image based on and/or from the content of the first output signal (e.g., the group of frames that were captured, stored, and accumulated with the first camera 140 at blocks 602-628). The computer 160 may create, produce, and/or generate the averaged intensity image in the same manner as the first camera 140 described above with respect to block 530 of method 500. The steps and/or processes performed at and/or at blocks 602-628, 634-656 of the second method 600 are substantially the same as those of corresponding blocks 502-528, 534-556 of the first method 500 and, therefore, are not described in detail.

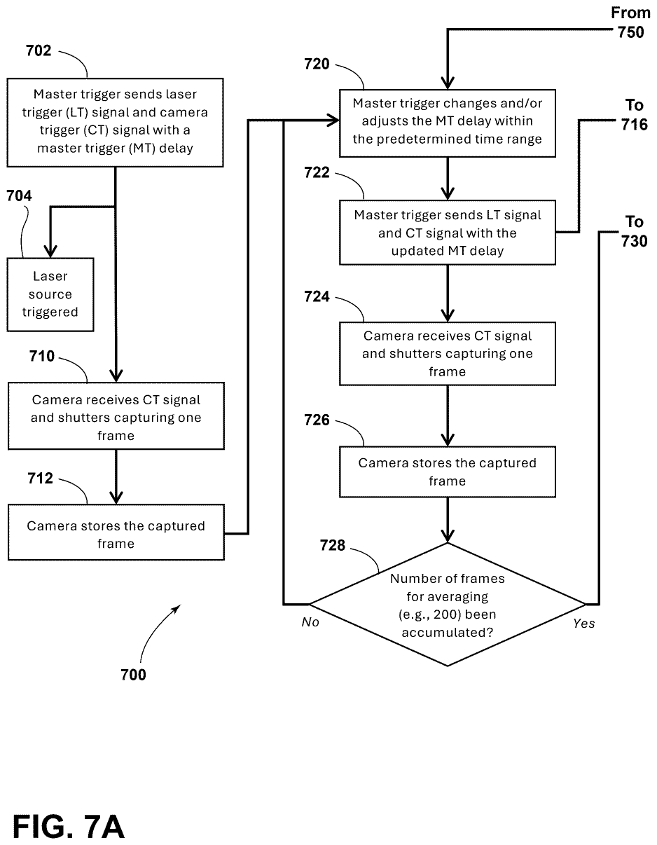

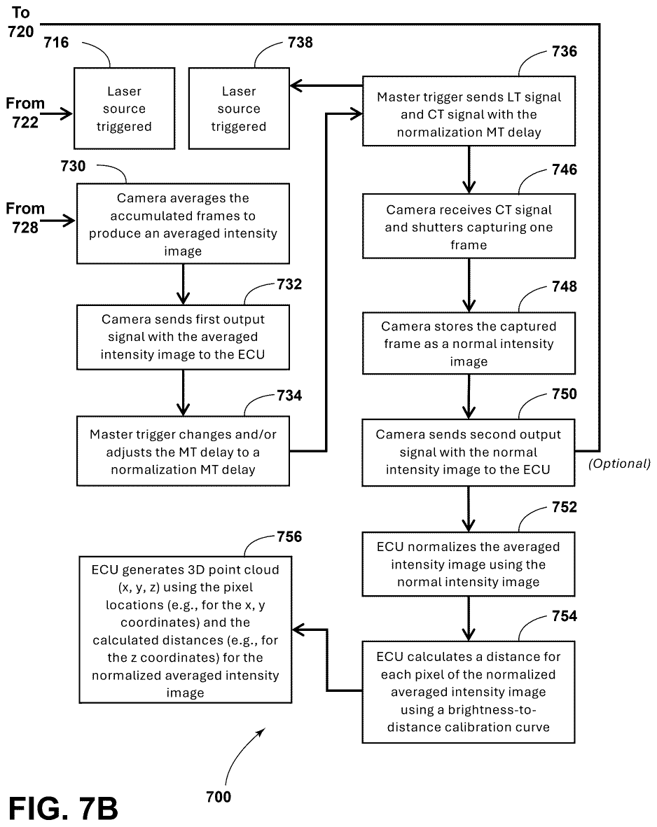

A third exemplary method 700 of 3D imaging with the system 100, such as the system 1001 of FIG. 1, the system 1002 of FIG. 2, the system 1003 of FIG. 3, and/or the system 1004 of FIG. 4, is generally depicted in FIGS. 7A and 7B. The third method 700 is similar to the first method 500 in many respects except the functions performed by the delay generator 120 in the first method 500 are incorporated into and performed by the master trigger 130 in the third method 700. The steps and/or processes performed at blocks 704, 712, 716, 724, 726, 730, 732, 738, and 748-756 of the third method 700 are substantially the same as those of corresponding blocks 504, 512, 516, 524, 526, 530, 532, 538, and 548-556 of the first method 500 and, therefore, are not described in detail.

At block 702 of the third method 700, the master trigger 130 sends a laser trigger signal (laser trigger signal) to the laser source 110 and sends a first camera trigger signal (C1T signal) to the first camera 140 with a first camera delay (C1 delay). The master trigger 130 may determine and/or set the C1 delay such that the shutter of the first camera 140 at block 710 begins within the predetermined time range.

At block 710, the first camera 140 receives the C1T signal from the master trigger 130. The C1T signal activates, triggers, and/or shutters the first camera 140 and/or its sensor array to measure and/or collect the reflected photons 22 of the laser 20 and capture a frame.

At block 720, the master trigger 130 modifies, adjusts, and/or changes the C1 delay. Modifying, adjusting, and/or changing the C1 delay includes changing and/or adjusting the C1 delay within a predetermined time range, such as switching and/or changing the C1 delay from one time, number, and/or value within the predetermined time range to another different time, number, and/or value within the predetermined time range.

At block 722, the master trigger 130 sends another (e.g., a second) LT signal to the laser source 110 and sends another (e.g., a second) C1T signal to the first camera 140 with the updated and/or modified C1 delay from block 720.

At block 728, the first camera 140 determines whether a sufficient and/or predetermined number of captured frames have been stored and/or accumulated to form and/or produce an averaged intensity image as described above with respect to block 528. If a sufficient number of captured frames have not been stored and/or accumulated, the method 700 returns to block 720 and the steps/processes of blocks 716, 720-728 are repeated in a looped manner to capture, store, and accumulate a sufficient number of frames (e.g., the predetermined number of frames) to produce an averaged intensity image. As such, the method 700 includes continually adjusting and/or modifying the C1 delay within the predetermined time range (i.e., jittering the C1 delay) with and/or via the master generator 130 while capturing, storing, and/or accumulating frames in the first camera 140 to produce the averaged intensity image. Once a sufficient number of captured frames have been stored and/or accumulated, the method 700 proceeds to block 730.

At block 734, the master trigger 130 modifies, adjusts, and/or changes the C1 delay for capturing a normal intensity image that will be associated with the averaged intensity image provided to the computer 160 at block 732. Modifying, adjusting, and/or changing the C1 delay includes reducing and/or shortening the C1 delay relative to the C1 delay that was utilized when capturing, storing, and/or accumulating frames on the first camera 140 at blocks 702-728. The master trigger 130 may determine, set, and/or modify the C1 delay such that the shutter of the first camera 140 at block 746 begins earlier than and/or before arrival of the reflected photons 22 (e.g., before the start of the predetermined time range, at and/or about the start of the predetermined time range) and the reflected photons 22 arrive at the first camera 140 during a fully open period of the shutter.

At block 736, the master trigger 130 sends a LT signal to the laser source 110 and sends a C1T signal to the first camera 140 with the modified and/or updated C1 delay from block 734.

At block 746, the first camera 140 receives the C1T signal from the master trigger 130. The C1T signal activates, triggers, and/or shutters the first camera 140 and/or its sensor array to measure and/or collect the reflected photons 22 of the laser 20 and capture a frame that is to be utilized as the normal intensity image.

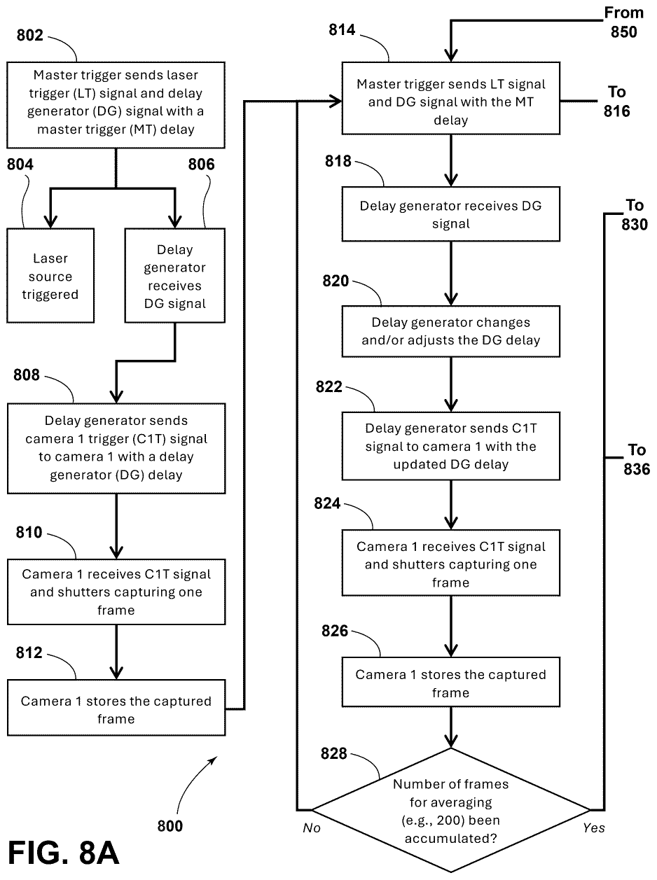

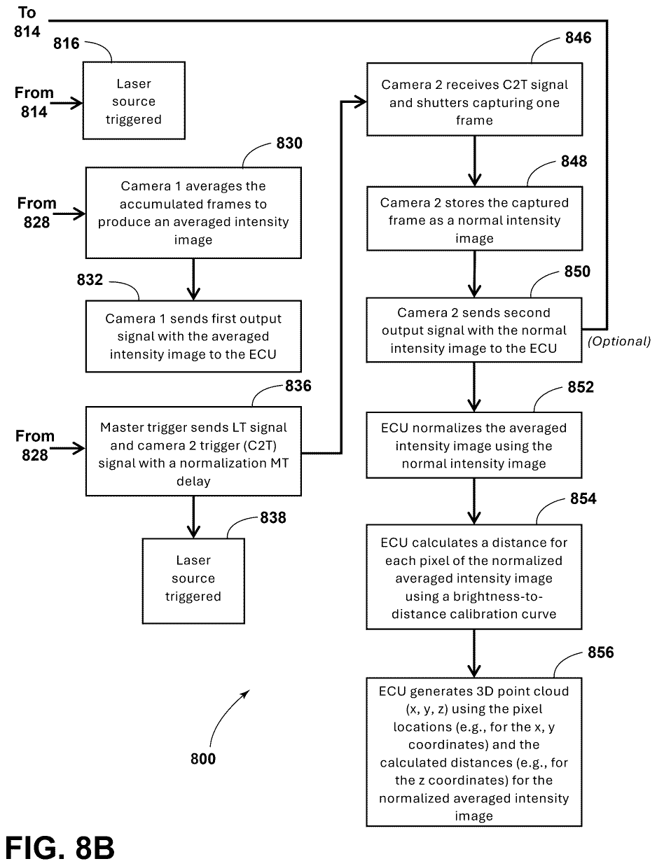

A fourth exemplary method 800 of 3D imaging with the system 100, such as the system 1003 of FIG. 3, is generally depicted in FIGS. 8A and 8B. The fourth method 800 is similar to the first method 500 in many respects except a second camera 150 is utilized to capture the frame for the normalized intensity image and transmits the normalized intensity image to the computer 160 via sending the second output signal to the computer 160. The steps and/or processes performed at blocks 802-832, 838, and 852-856 of the fourth method 800 are substantially the same as those of corresponding blocks 502-532, 538, and 552-556 of the first method 500 and, therefore, are not described in detail.

At block 836, the master trigger 130 sends a LT signal to the laser source 110 and sends a second camera trigger signal (C2T signal) to the second camera 150 with a second camera delay (C2 delay). The master trigger 130 may determine, set, and/or modify the C2 delay such that the shutter of the second camera 150 at block 846 begins earlier than and/or before arrival of the reflected photons 22 (e.g., before the start of the predetermined time range, at and/or about the start of the predetermined time range) and the reflected photons 22 arrive at the second camera 150 during a fully open period of the shutter. The fourth method 800 may proceed to block 836 once a sufficient number of captured frames have been stored and/or accumulated by the first camera 140 at block 828. The steps and/or processes of block 836 may be performed subsequently to and/or in parallel with those of block 830 and/or block 832.

At block 846, the second camera 150 receives the C2T signal from the master trigger 130. The C2T signal activates, triggers, and/or shutters the second camera 150 and/or its sensor array to measure and/or collect the reflected photons 22 of the laser 20 and capture a frame that is to be utilized as the normal intensity image. As such, this captured frame defines and/or forms the normal intensity image, and/or may simply be considered to be the normal intensity image.

At block 848, the second camera 150 saves and/or stores the frame captured at block 846 (i.e., the normal intensity image).

At block 850, the second camera 150 (e.g., the chip, ECU, processor, and/or control module thereof) generates and/or provides a second output signal, which includes the normal intensity image, and transmits the second output signal to the computer 160.

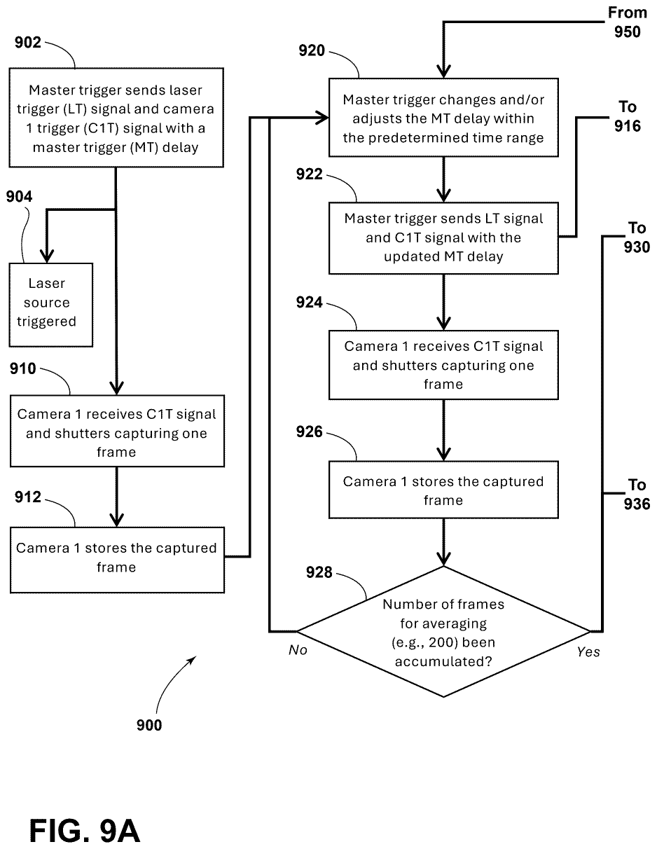

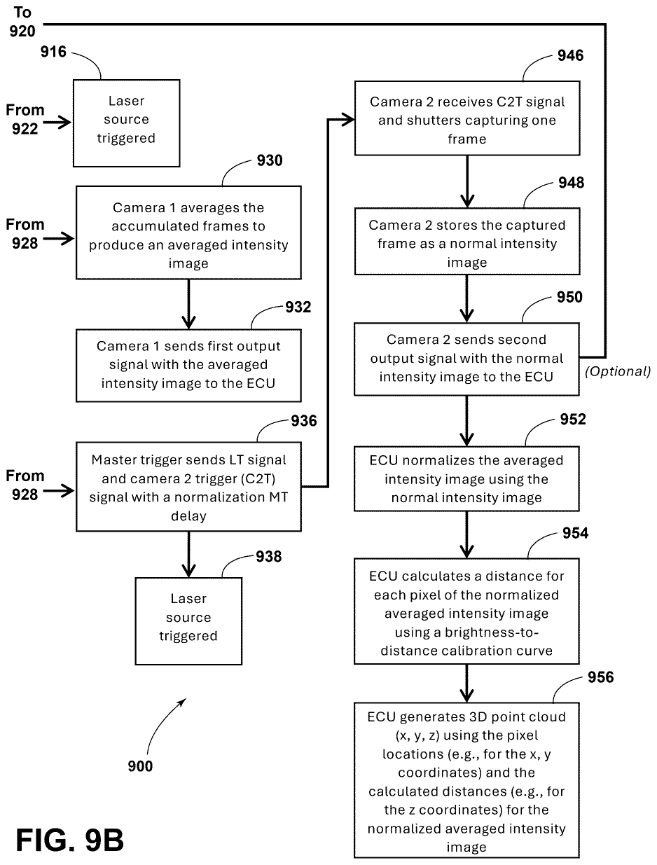

A fifth exemplary method 900 of 3D imaging with the system 100, such as the system 1003 of FIG. 3 and/or the system 1004 of FIG. 4, is generally depicted in FIGS. 9A and 9B. The fifth method 900 is similar to the third method 700 in many respects except a second camera 150 is utilized to capture the frame for the normalized intensity image and transmits the normalized intensity image to the computer 160 via sending the second output signal to the computer 160. The steps and/or processes performed at blocks 902, 904, 910, 912, 920-932, 938, 952-956 of the fifth method 900 are substantially the same as those of corresponding blocks 702, 704, 710, 712, 720-732, 738, 752-756 of the third method 700 and, therefore, are not described in detail.

At block 936, the master trigger 130 sends a LT signal to the laser source 110 and sends a second camera trigger signal (C2T signal) to the second camera 150 with a second camera delay (C2 delay). The master trigger 130 may determine, set, and/or modify the C2 delay such that the shutter of the second camera 150 at block 946 begins earlier than and/or before arrival of the reflected photons 22 (e.g., before the start of the predetermined time range, at and/or about the start of the predetermined time range) and the reflected photons 22 arrive at the second camera 150 during a fully open period of the shutter. The fifth method 900 may proceed to block 936 once a sufficient number of captured frames have been stored and/or accumulated by the first camera 140 at block 928. The steps and/or processes of block 936 may be performed subsequently to and/or in parallel with those of block 930 and/or block 932.

At block 946, the second camera 150 receives the C2T signal from the master trigger 130. The C2T signal activates, triggers, and/or shutters the second camera 150 and/or its sensor array to measure and/or collect the reflected photons 22 of the laser 20 and capture a frame that is to be utilized as the normal intensity image.

At block 948, the second camera 150 saves and/or stores the frame captured at block 946 (i.e., the normal intensity image).

At block 950, the second camera 150 (e.g., the chip, ECU, processor, and/or control module thereof) generates and/or provides a second output signal, which includes the normal intensity image, and transmits the second output signal to the computer 160.

Like the first method 500, the methods 600, 700, 800, 900 may include continually repeating their above-described processes and/or steps to generate 3D point clouds for a plurality of (e.g., sequentially generated and/or produced) normalized averaged intensity images to provide real-time 3D imaging of the environment 10 and/or one or more objects 12 therein.

While not depicted in the drawings, the methods 700, 800, 900 may alternatively include the first camera 140 providing the stored/accumulated frames to the computer 160 via the first output signal at blocks 730, 830, 930 (e.g., as in block 630 of the second method 600) and the computer 160 creating, generating, and/or producing the averaged intensity image at blocks 732, 832, 932 (e.g., as in block 632 of the second method 600).

In one exemplary system 100, the laser source 110 is a home-built 905 nm nanosecond laser made from an EPC9150 driver board and an OSRAM SPL S1L90A_3 A01 laser diode. The laser source 110 has an average laser power of 0.3 mW at 1.25 kHz, a pulse duration of 3.9 ns, and a peak power ~50 W. The cameras 140, 150 are each a Basler acA720-520 um (native resolution: 720×540 pixels; readout noise: 3 electrons; dark current: 20 e/s; minimum exposure time: 1 μs), which have an intrinsic shutter jitter of approximately 15 ns due to the employed timing circuitry. The cameras 140, 150 run at 1.25 kilo-frames/s with a reduced resolution of 260×200 pixels. The master trigger 130 was provided by an Arduino Uno board. The delay generator 120 was provided by a BNC 555. The predetermined time range for jittering the DG delay and/or the C1T delay was set to 100 ns, which corresponds to a detection range of approximately 15 meters. This exemplary system 100 achieved an accuracy better than 50 cm and a precision better than 16 cm. With the maximum detection range of 15 meters, the accuracy was about 3% while the precision amounts to 1% of the full range. The detection range of this exemplary system 100 is greater than the detection range of conventional 3D imaging systems utilizing ITOF sensors.

In another exemplary system 100, the laser source 110 is a home-built 905 nm nanosecond laser made from an EPC9150 driver board and an OSRAM SPL S1L90A_3 A01 laser diode. The laser source 110 has an average laser power of 0.3 mW at 1.25 kHz, a pulse duration of 3.9 ns, and a peak power ~50 W. The cameras 140, 150 are each a Ximea camera (MC031Y), which implemented a multi-exposure function that can integrate up to 4096 frames on-chip before readout. The master trigger 130 was provided by an Arduino Uno board. The delay generator 120 was provided by a BNC 555. When 200 frames were accumulated and averaged on the camera 140 to obtain the averaged intensity image, the system 100 was able to detect and image an object located 53 m away. Note that the multi-exposure mode increases the overall camera noise and degrades image quality. Because of this, in at least this exemplary system 100, there is a limit to the number of frames that can be accumulated and averaged on the camera 140 to obtain the averaged intensity image. Besides the improved sensitivity, another important benefit of using on-chip integration (i.e., utilizing the camera 140 to accumulate and average the captured frames) is that the laser repetition rate of the laser source 110 can be significantly increased. In single exposure mode, the readout bandwidth of the camera 140 and thus the camera frame rate limit the laser repetition rate, which is currently at a few kHz, also at a reduced spatial resolution. With the multiple exposure mode, because averaging is done on-chip, the readout speed can be quite low, (e.g., tens of frames/second). This allows decoupling of the laser repetition rate from the camera readout speed. A laser repetition rate of up to 30 kHz was achieved using the Ximea camera in this exemplary system 100. Such a high exposure rate ensures the overall frame rate is not impacted by the requirement of a higher number of frames, which allows for detection of weaker signals as previously explained. The decoupling also allows a much higher spatial resolution to be utilized. For example, at 50 frames per second, the Ximea camera can stream at a resolution of 3 MPixels (2064×1544) while integrating 200 laser pulses in each averaged intensity image. This represents an unprecedented resolution for LiDAR devices.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase “at least one of” followed by successive elements separate by the word “and” (e.g., “at least one of A and B”) is to be interpreted the same as “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure. In examples, a computer may include an electronic controller and/or include an electronic processor, such as a programmable microprocessor and/or microcontroller. In embodiments, a computer may include, for example, an application specific integrated circuit (ASIC). A computer may include a central processing unit (CPU), a memory (e.g., a non-transitory computer-readable storage medium), and/or an input/output (I/O) interface. A computer may be configured to perform various functions, including those described in greater detail herein, with appropriate programming instructions and/or code embodied in software, hardware, and/or other medium. In embodiments, a computer may include a plurality of controllers. In embodiments, a computer may be connected to a display, such as a touchscreen display. It should be understood that a computer/computing device, an electronic control unit (ECU), a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. A 3D imaging system, comprising:
a laser source configured to emit a laser pulse;
a camera arranged and oriented to collect reflected photons of the laser pulse emitted by the laser source, the camera configured to accumulate a plurality of frames and to provide a first output signal including the plurality of frames and/or an averaged intensity image;
a master trigger connected to the laser source and/or the camera, the master trigger configured to provide a laser trigger signal to the laser source; and
a computer communicatively coupled to the camera;
wherein the computer is configured to:
receive the first output signal from the camera;
receive a second output signal including a normal intensity image;
provide a normalized averaged intensity image via normalizing the averaged intensity image based on the normal intensity image;
determine a plurality of distances based on the normalized averaged intensity image and a brightness-distance calibration curve; and
provide a 3D point cloud based on the plurality of determined distances and a plurality of pixel positions.

2. The system of claim 1, wherein the system is implemented in a light detection and ranging (LiDAR) apparatus.

3. The system of claim 1, wherein:
the first output signal includes the averaged intensity image; and
the camera is configured to average pixel outputs across the plurality of frames to obtain the averaged intensity image.

4. The system of claim 1, wherein:
the first output signal includes the plurality of frames; and
the computer is configured to average pixel outputs across the plurality of frames included in the first output signal to obtain the averaged intensity image.

5. The system of claim 1, wherein the master trigger is connected to the camera and is configured to provide a camera trigger signal to the camera with a delay relative to providing the laser trigger signal.

6. The system of claim 5, wherein:
the camera is further configured to capture a frame that defines the normal intensity image and to provide the second output signal to the computer; and
the master trigger is configured to adjust the delay such that:
when capturing and accumulating the plurality of frames, the camera is shuttered during a predetermined time range; and
when capturing the frame that defines the normal intensity image, the reflected photons of the laser pulse arrive at the camera during a full exposure period of the shutter of the camera.

7. The system of claim 5, wherein the master trigger is configured to continuously adjust the delay within a predetermined time range while capturing and accumulating the plurality of frames with the camera such that the plurality of frames include a jittering rising edge.

8. The system of claim 1, further comprising a second camera arranged and oriented to collect reflected photons of the laser beam emitted by the laser source, wherein:
the second camera is communicatively coupled to the computer; and
the second camera is configured to capture a frame that defines the normal intensity image and to provide the second output signal to the computer.

9. The system of claim 1, further comprising a delay generator connected to the camera, wherein:
the master trigger is further configured to provide a delay generator signal to the delay generator with a master trigger delay relative to providing the laser trigger signal; and
the delay generator is configured to provide a camera trigger signal to the camera with a delay generator delay.

10. The system of claim 9, wherein:
the master trigger is configured to adjust the master trigger delay such that, when capturing and accumulating the plurality of frames, the camera is shuttered during a predetermined time range; and
the delay generator is configured to continuously adjust the delay generator delay within the predetermined time range while capturing and accumulating the plurality of frames with the camera such that the plurality of frames include a jittering rising edge.

11. The system of claim 10, wherein:
the camera is further configured to capture a frame that defines the normal intensity image and to provide the second output signal to the computer; and
the master trigger is configured to adjust the master trigger delay such that, when capturing the frame that defines the normal intensity image, the reflected photons of the laser pulse arrive at the camera during a full exposure period of the shutter of the camera.

12. A method of 3D imaging, comprising:
sending a laser trigger signal to a laser source;
sending a camera trigger signal to a camera with a delay;
emitting a laser pulse via the laser source;
shuttering the camera to measure reflected photons of the laser pulse and capture a frame;
accumulating a plurality of frames with the camera;
sending a first output signal from the camera to a computer, the first output signal including the plurality of accumulated frames and/or an averaged intensity image;
sending a second output signal to the computer, the second output signal including a normal intensity image;
normalizing, via the computer, the averaged intensity image based on the normal intensity image to obtain a normalized averaged intensity image;
determining, via the computer, a plurality of distances based on the normalized averaged intensity image and a brightness-distance calibration curve; and
providing, via the computer, a 3D point cloud including a plurality of 3D coordinates based on the plurality of determined distances and a plurality of pixel positions.

13. The method of claim 12, further comprising continuously adjusting the delay within a predetermined time range while accumulating the plurality of frames with the camera such that the plurality of frames include a jittering rising edge.

14. The method of claim 12, further comprising capturing another frame that defines the normal intensity image with the camera, and wherein the camera sends the second output signal to the computer.

15. The method of claim 14, further comprising adjusting the delay such that:
when capturing and accumulating the plurality of frames, the camera is shuttered during a predetermined time range; and
when capturing the another frame that defines the normal intensity image, the reflected photons of the laser pulse arrive at the camera during a full exposure period of the shutter of the camera.

16. The method of claim 12, further comprising obtaining the averaged intensity image via averaging pixel outputs across the plurality of accumulated frames.

17. The method of claim 12, wherein the laser trigger signal and the camera trigger signal are sent via a master trigger that is communicatively connected to the laser source and the camera.

18. The method of claim 12, further comprising providing a delay generator signal to a delay generator with a delay relative to providing the laser trigger signal, wherein:
the laser trigger signal and the delay generator signal are sent via a master trigger that is communicatively connected to the laser source and to the delay generator; and
the camera trigger signal is sent via the delay generator, which is communicatively connected to the camera.

19. The method of claim 18, further comprising:
adjusting the delay with which the delay generator signal is sent such that, when capturing and accumulating the plurality of frames with the camera, the camera is shuttered during a predetermined time range; and
continuously adjusting the delay with which the camera trigger signal is sent within the predetermined time range while capturing and accumulating the plurality of frames with the camera such that the plurality of frames include a jittering rising edge.

20. The method of claim 18, further comprising:
sending, via the master trigger, a second camera trigger signal to a second camera that is communicatively connected to the master trigger; and
capturing another frame that defines the normal intensity image with the second camera.
